(19) United States
(12) Patent Application Publication
(10) Pub. No.: US 2020/0134529 A1
(43) Pub. Date: Apr. 30, 2020

(54) INTELLIGENT PRIMING OF MOBILE DEVICE FOR FIELD SERVICE

(71) Applicant: salesforce.com, inc., San Francisco, CA (US)

(72) Inventors: Puneet DHALIWAL, San Francisco, CA (US); Victor OLIVEROS, San Francisco, CA (US); Sheila Bernadette CHRISTIAN, San Francisco, CA (US); Nathan BECK, San Francisco, CA (US); Audrey WU, San Francisco, CA (US)

(21) Appl. No.: 16/175,629

(22) Filed: Oct. 30, 2018

(51) Int. Cl. G06Q 10/06; G06F 16/178; G06Q 10/10

(52) U.S. Cl. CPC G06Q 10/06314; G06Q 10/1097; G06F 16/178

(57) ABSTRACT

Systems and methods are provided for intelligent priming of mobile devices for the representatives of an organization who make service calls or client visits. With intelligent priming, in some embodiments, the systems and methods analyze each potential service appointment or customer/client visit separately, identify a potential set of information most relevant for the appointment or visit, and download the same to the representatives' mobile device. This reduces the time required and amount of information for priming. In some embodiments, the intelligent priming systems and methods can also notify representatives of when they should prime or download, generate recommendations for the information to be primed or downloaded, and provide an indicator to the representative regarding the status of priming or download.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to computing device, and more specifically for intelligent mobile priming for a field service.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

For any organization that provides products or services to customers or clients in the field (e.g., at a client site), the organization's field-representatives should be provided with the information they need in order to fulfill any service appointments or customer visits. Typically, such information might be stored as electronic records or digital objects in a database system that is maintained by the organization or a service provider and accessed via a network. In situations where the representative may not have access to a suitable network connection (e.g., landline, cellular, or wireless) in the field through which the representative can access the organization's databases—e.g., because the client site is remote or the representative will be working in a location, such as a basement, where connectivity is poor; or there is a lack of reliable network connection due to cellular tower service outage, or extreme weather)—it may be desirable that the representative's mobile device be “primed” or downloaded with information in advance of the appointment or visit.

### BRIEF DESCRIPTION OF THE DRAWINGS

FIG. 1 illustrates a block diagram of an example environment according to some embodiments.

FIG. 2 illustrates a block diagram of another example environment according to some embodiments.

FIG. 3 illustrates a simplified diagram of a system for intelligent priming of a mobile device according to some embodiments.

FIG. 4 illustrates a diagram of a process flow for intelligent priming of a mobile device according to some embodiments.

FIG. 5 illustrates a diagram of a process flow for synchronizing for intelligent priming on a mobile device according to some embodiments.

FIG. 6 illustrates a screenshot of a platform for defining different datasets based on a default configuration dataset of a client done by an administrator according to some embodiment.

In the figures, elements having the same designations have the same or similar functions.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one skilled in the art Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. These specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated in to other embodiments unless specifically described otherwise or if the one or more features would make an embodiment non-functional.

### Example Environment

The system and methods of the present disclosure can include, incorporate, or operate in conjunction with or in the environment of a database, which in some embodiments can implemented as a multi-tenant, cloud-based architecture. Multi-tenant cloud-based architectures have been developed to improve collaboration, integration, and community-based cooperation between customer tenants without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multitenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost-effective sharing of similar application features between multiple sets of users.

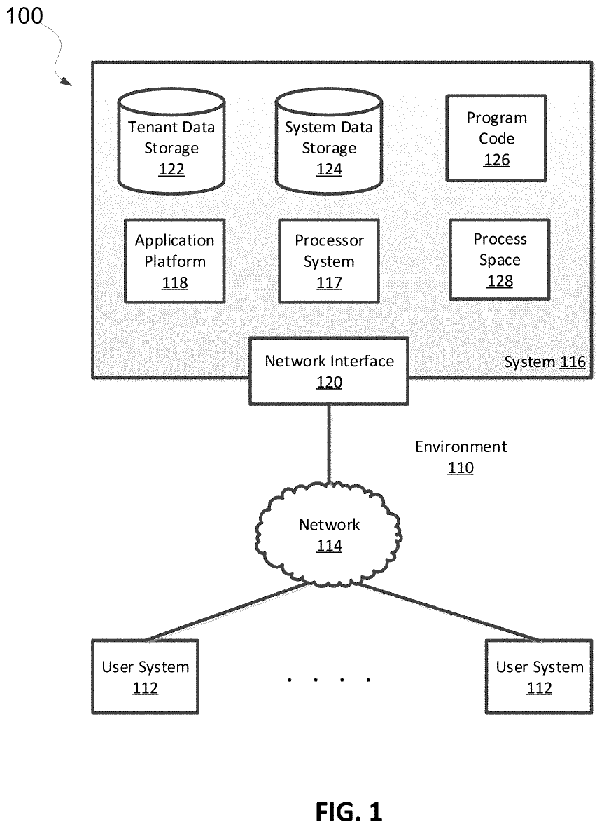

FIG. 1 illustrates a block diagram of an example environment 110 according to some embodiments. Environment 110 may include user systems 112, network 114, system 116, processor system 117, application platform 118, network interface 120, tenant data storage 122, system data storage 124, program code 126, and process space 128 for executing data base system processes and tenant-specific processes, such as running applications as part of an application hosting service. In other embodiments, environment 110 may not have all of the components listed and/or may have other elements instead of, or in addition to, those listed above.

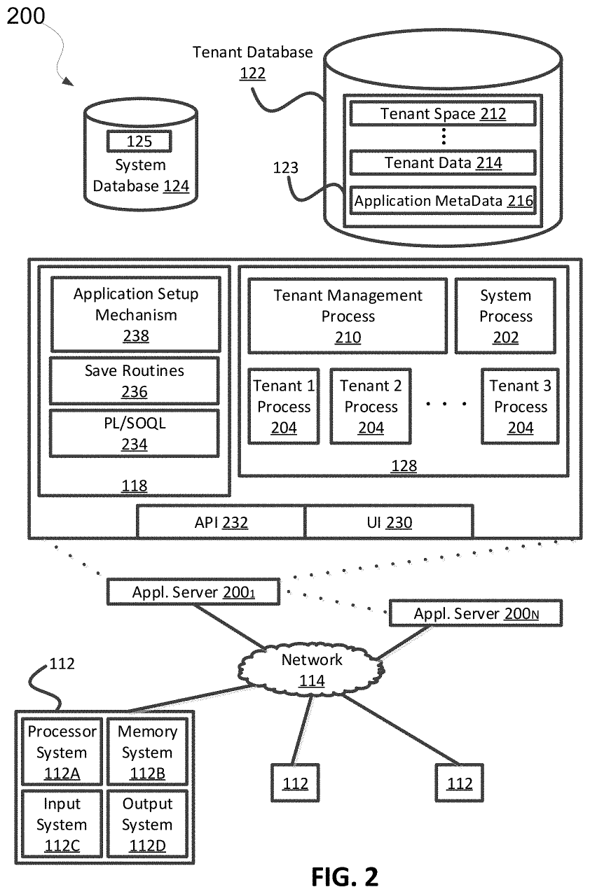

In some embodiments, the environment 110 is an environment in which an on-demand database service exists. A user system 112 may be any machine or system that is used by a user to access a database user system. For example, any of user systems 112 can be a handheld computing device, a mobile phone, a laptop computer, a notepad computer, a work station, and/or a network of computing devices. As illustrated in FIG. 1 (and in more detail in FIG. 2) user systems 112 might interact via a network 114 with an on-demand database service, which is system 116.

An on-demand database service, such as that which can be implemented using the system 116, is a service that is made available to users outside of the enterprise(s) that own, maintain or provide access to the system 116. As described above, such users do not need to necessarily be concerned with building and/or maintaining the system 116. Instead, resources provided by the system 116 may be available for such users' use when the users need services provided by the system 116—e.g., on the demand of the users. Some on-demand database services may store information from one or more tenants stored into tables of a common database image to form a multi-tenant database system (MTS). Accordingly, the “on-demand database service 116” and the “system 116” will be used interchangeably herein. The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image may include one or more database objects. A relational database management system (RDBMS) or the equivalent may execute storage and retrieval of information against the database object(s).

The application platform 118 may be a framework that allows the applications of system 116 to run, such as the hardware and/or software infrastructure, e.g., the operating system. In an embodiment, on-demand database service 116 may include an application platform 118 that enables creating, managing, and executing one or more applications developed by the provider of the on-demand database service, users accessing the on-demand data base service via user systems 112, or third-party application developers accessing the on-demand database service via user systems 112.

The users of user systems 112 may differ in their respective capacities, and the capacity of a particular user system 112 might be entirely determined by permissions (permission levels) for the current user. For example, where a salesperson is using a particular user system 112 to interact with system 116, that user system has the capacities allotted to that salesperson. However, while an administrator is using that user system 112 to interact with system 116, that user system 112 has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

The network 114 is any network or combination of networks of devices that communicate with one another. For example, the network 114 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global internetwork of networks often referred to as the “Internet” with a capital “I” that network will be used in many of the examples herein. However, it should be understood that the networks that the present embodiments might use are not so limited, although TCP/IP is a frequently implemented protocol.

The user systems 112 might communicate with system 116 using TCP/IP and, at a higher network level, use other common Internet protocols to communicate, such as hypertext transfer protocol (HTTP), file transfer protocol (FTP), Andrew file system (AFS), wireless application protocol (WAP), etc. In an example where HTTP is used, user system 112 might include an HTTP client commonly referred to as a “browser” for sending and receiving HTTP messages to and from an HTTP server at system 116. Such an HTTP server might be implemented as the sole network interface between system 116 and network 114, but other techniques might be used as well or instead. In some implementations, the interface between system 116 and network 114 includes load sharing functionality, such as round-robin HTTP request distributors to balance loads and distribute incoming HTTP requests evenly over a plurality of servers. At least for the users that are accessing that server, each of the plurality of servers has access to the MTS data; however, other alternative configurations may be used instead.

In some embodiments, the system 116, shown in FIG. 1, implements a web-based customer relationship management (CRM) system. For example, in one embodiment, system 116 includes application servers configured to implement and execute CRM software applications as well as provide related data, code, forms, webpages and other information to and from user systems 112 and to store to, and retrieve from, a database system related data, objects, and web page content. With a multi-tenant system, data for multiple tenants may be stored in the same physical database object. However, tenant data typically is arranged so that data of one tenant is kept logically separate from that of other tenants so that one tenant does not have access to another tenant's data, unless such data is expressly shared. In certain embodiments, the system 116 implements applications other than, or in addition to, a CRM application. For example, system 116 may provide tenant access to multiple hosted (standard and custom) applications, including a CRM application. User (or third-party developer) applications, which may or may not include CRM, may be supported by the application platform 118, which manages creation, storage of the applications into one or more database objects, and executing of the applications in a virtual machine in the process space of the system 116.

One arrangement for elements of the system 116 is shown in FIG. 1, including the network interface 120, the application platform 118, the tenant data storage 122 for tenant data 123, the system data storage 124 for system data 125 accessible to system 116 and possibly multiple tenants, the program code 126 for implementing various functions of the system 116, and the process space 128 for executing MTS system processes and tenant-specific processes, such as running applications as part of an application hosting service. Additional processes that may execute on system 116 include database indexing processes.

Several elements in the system shown in FIG. 1 include conventional, well-known elements that are explained only briefly here. For example, each of the user systems 112 could include a desktop personal computer, workstation, laptop, notepad computer, personal digital assistant (PDA), cellphone, or any wireless access protocol (WAP) enabled device or any other computing device capable of interfacing directly or indirectly to the Internet or other network connection. Each of the user systems 112 typically runs an HTTP client, e.g., a browsing program, such as Microsoft's Internet Explorer browser, Netscape's Navigator browser, Opera's browser, or a WAP-enabled browser in the case of a cell phone, notepad computer, PDA or other wireless device, or the like, allowing a user (e.g., subscriber of the multi-tenant database system) of the user systems 112 to access, process, and view information, pages, and applications available to it from the system 116 over the network 114. Each of the user systems 112 also typically includes one or more user interface devices, such as a keyboard, mouse, trackball, touchpad, touch screen, pen or the like, for interacting with a graphical user interface (GUI) provided by the browser on a display (e.g., a monitor screen, liquid crystal display (LCD) monitor, light emitting diode (LED) monitor, organic light emitting diode (OLED) monitor, etc.) in conjunction with pages, forms, applications, and other information provided by the system 116 or other systems or servers. For example, the user interface device can be used to access data and applications hosted by system 116, and to perform searches on stored data, and otherwise allow a user to interact with various GUI pages that may be presented to a user. As discussed above, embodiments are suitable for use with the Internet, which refers to a specific global internet work of networks. However, it should be understood that other networks can be used instead of the Internet, such as an intranet, an extranet, a virtual private network (VPN), a non-TCP/IP based network, any LAN or WAN or the like.

According to one embodiment, each of the user systems 112 and all of its components are operator configurable using applications, such as a browser, including computer code run using a central processing unit (CPU) such as an Intel Pentium® processor or the like. Similarly, system 116 (and additional instances of an MTS, where more than one is present) and all of their components might be operator configurable using application(s) including computer code to run using a CPU such as the processor system 117, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring the system 116 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a read only memory (ROM) or random-access memory (RAM), or provided on any media capable of storing program code, such as any type of rotating media including floppy disks, optical discs, digital versatile disk (DVD), compact disk (CD), Microdrive, and magneto-optical disks, and magnetic or optical cards, Nano systems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connections is well known (e.g., extranet, virtual private network (VPN), LAN, etc.) using any communication medium and protocols (e.g., TCP/IP, HTTP, HTTPS, Ethernet, etc.) as are well-known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VB Script, and many other programming languages as are well known may be used. (Java™ is a trademark of Sun MicroSystems, Inc.).

According to one embodiment, the system 116 is configured to provide webpages, forms, applications, data and media content to the user (client) systems 112 to support the access by the user systems 112 as tenants of the system 116. As such, the system 116 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., object-oriented database management system (OODBMS) or rational database management system (RDBMS)) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates the environment 110, which may be used to implement embodiments described herein. FIG. 2 further illustrates elements of system 116 and various interconnections, according to some embodiments. FIG. 2 shows that each of the user systems 112 may include a processor system 112A, a memory system 112B, an input system 112C, and an output system 112D. FIG. 2 shows the network 114 and the system 116. FIG. 2 also shows that the system 116 may include the tenant data storage 122, the tenant data 123, the system data storage 124, the system data 125, a user interface (UI) 230, an application program interface (API) 232, a PL/Salesforce.com object query language (PL/SOQL) 234, save routines 236, an application setup mechanism 238, applications servers 2001-200N, a system process space 202, tenant process spaces 204, a tenant management process space 210, a tenant storage area 212, a user storage 214, and application metadata 216. In other embodiments, environment 110 may not have the same elements as those listed above and/or may have other elements instead of, or in addition to, those listed above.

The user systems 112, the network 114, the system 116, the tenant data storage 122, and the system data storage 124 were discussed above in FIG. 1. Regarding the user systems 112, the processor system 112A may be any combination of one or more processors. The memory system 112B may be any combination of one or more memory devices, short term, and/or long-term memory. The input system 112C may be any combination of input devices, such as one or more keyboards, mice, trackballs, scanners, cameras, and/or interfaces to networks. The output system 112D may be any combination of output devices, such as one or more monitors, printers, and/or interfaces to networks. As shown in FIG. 2, the system 116 may include the network interface 120 (of FIG. 1) implemented as a set of HTTP application servers 200, the application platform 118, the tenant data storage 122, and the system data storage 124. Also shown is system process space 202, including individual tenant process spaces 204 and the tenant management process space 210. Each application server 200 may be configured to access tenant data storage 122 and the tenant data 123 therein, and the system data storage 124 and the system data 125 therein to serve requests of the user systems 112. The tenant data 123 might be divided into individual tenant storage areas 212, which can be either a physical arrangement and/or a logical arrangement of data. Within each tenant storage area 212, the user storage 214 and the application metadata 216 might be similarly allocated for each user. For example, a copy of a user's most recently used (MRU) items might be stored to the user storage 214. Similarly, a copy of MRU items for an entire organization that is a tenant might be stored to the tenant storage area 212. The UI 230 provides a user interface and the API 232 provides an application programmer interface to the system 116 resident processes and to users and/or developers at the user systems 112. The tenant data and the system data may be stored in various databases, such as one or more Oracle™ databases.

The application platform 118 includes an application setup mechanism 238 that supports application developers' creation and management of applications, which may be saved as metadata into tenant data storage 122 by the save routines 236 for execution by subscribers as one or more tenant process spaces 204 managed by the tenant management process 210, for example. Invocations to such applications may be coded using PL/SOQL 234 that provides a programming language style interface extension to the API 232. Some embodiments of PL/SOQL language are discussed in further detail in U.S. Pat. No. 7,730,478, filed September 2007, entitled, “Method and System For Allowing Access to Developed Applications Via a Multi-Tenant On-Demand Database Service,” which is incorporated herein by reference. Invocations to applications may be detected by one or more system processes, which manage retrieving the application metadata 216 for the subscriber, making the invocation and executing the metadata as an application in a virtual machine.

Each application server 200 may be communicably coupled to database systems, e.g., having access to the system data 125 and the tenant data 123, via a different network connection. For example, one application server 2001 might be coupled via the network 114 (e.g., the Internet), another application server 200N−1 might be coupled via a direct network link, and another application server 200N might be coupled by yet a different network connection. TCP/IP are typical protocols for communicating between application servers 200 and the database system. However, it will be apparent to one skilled in the art that other transport protocols maybe used to optimize the system depending on the network connection used.

In certain embodiments, each application server 200 is configured to handle requests for any user associated with any organization that is a tenant. Because it is desirable to be able to add and remove application servers from the server pool at any time for any reason, there is preferably no server affinity for a user and/or organization to a specific application server 200. In one embodiment, therefore, an interface system implementing a load balancing function (e.g., an F5 Big-IP load balancer) is communicably coupled between the application servers 200 and the user systems 112 to distribute requests to the application servers 200. In one embodiment, the load balancer uses a least connections algorithm to route user requests to the application servers 200. Other examples of load balancing algorithms, such as round robin and observed response time, also can be used. For example, in certain embodiments, three consecutive requests from the same user could hit three different application servers 200, and three requests from different users could hit the same application server 200. In this manner, the system 116 is multi-tenant, wherein the system 116 handles storage of, and access to, different objects, data and applications across disparate users and organizations.

As an example of storage, one tenant might be a company that employs a sales force where each salesperson uses the system 116 to manage his or her sales process. Thus, a user might maintain contact data, leads data, customer follow-up data, performance data, goals and progress data, etc., all applicable to that user's personal sales process (e.g., in the tenant data storage 122). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by the system 116 that are allocated at the tenant level while other data structures might be managed at the user level. Because a MTS might support multiple tenants including possible competitors, the MTS should have security protocols that keep data, applications, and application use separate. Also, because many tenants may opt for access to a MTS rather than maintain their own system, redundancy, up-time, and backup are additional functions that may be implemented in the MTS. In addition to user-specific data and tenant specific data, the system 116 might also maintain system level data usable by multiple tenants or other data. Such system level data might include industry reports, news, postings, and the like that are sharable among tenants.

In certain embodiments, the user systems 112 (which may be client systems) communicate with the application servers 200 to request and update system-level and tenant level data from the system 116 that may require sending one or more queries to the tenant data storage 122 and/or the system data storage 124. The system 116 (e.g., an application server 200 in the system 116) automatically generates one or more structured query language (SQL) statements (e.g., one or more SQL queries) that are designed to access the desired information. The system data storage 124 may generate query plans to access the requested data from the database.

In a database system, such as system 116 shown and described with respect to FIGS. 1 and 2, data or information may be organized or arranged in categories or groupings. Each database can generally be viewed as a collection of objects, such as a set of logical tables, containing data fitted into predefined categories. A “table” is one representation of a data object and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields.

In a CRM system, for example, these categories or groupings can include various standard entities, such as account, contact, lead, opportunity, group, case, knowledge article, etc., each containing pre-defined fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants.

In some multi-tenant database systems, tenants may be allowed to create and store custom objects, or they may be allowed to customize standard entities or objects, for example by creating custom fields for standard objects, including custom index fields. Systems and methods for creating custom objects as well as customizing standard objects in a multi-tenant database system are described in further detail in U.S. Pat. No. 7,779,039, filed Apr. 2, 2004, entitled “Custom Entities and Fields in a Multi-Tenant Database System,” which is incorporated herein by reference. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

### Intelligent Mobile Priming

Some organizations using a customer relationship management (CRM) system, such as the multi-tenant database system 116 described above, may be called upon to provide support or services to one or more of their respective customers, clients, leads, etc. in the field. For example, organizations such as cable or telephone service providers may send out technicians to their customers' premises (e.g., homes or offices) to install or repair equipment (e.g., set-top boxes, wireless equipment, etc.). As another example, an organization such as an accounting firm may send out one or more employees out to a client site to audit that client's accounts.

For an organization that provides products or services to customers or clients in the field (e.g., at a client site), the organization's field representatives should be provided with all of the information they need in order to fulfill any service appointments or visits. Typically, such information might be stored as electronic records or digital objects in a database system, such as, for example, the multi-tenant database system 116. In situations where the representative may not have access to a suitable network connection (e.g., landline, cellular, or wireless) in the field through which the representative can access the organization's databases—e.g., because the client site is remote or the representative will be working in a location, such as a basement, where connectivity is poor; or there is a lack of reliable network connection due to cellular tower service outage, or extreme weather)—it may be desirable that the representative's mobile device (such as a user system 112) be “primed” or downloaded with information in advance of the appointment or visit.

Systems have been developed to provide for such priming or download of information. Such systems are set up to download information that might be relevant or useful for the field appointment or visit. Because so much information can be collected and maintained for an organization's customers, clients, leads, etc., with existing priming systems the download of information can be time-consuming, e.g., taking upwards of 45 mins to complete (time that a technician could potential spend more productively somewhere else or doing something different). Furthermore, not all downloaded information will be necessary for any given appointment. As an example, an accountant of an accounting firm visiting a client for auditing may have her or his mobile device (e.g., cellular phone, laptop, notebook, or other mobile user system 112) be downloaded with that client's accounting dataset which may include auditing, corporate accounting, tax accounting, financial accounting and etc., but the accountant really only needs an auditing dataset for the respective visit. In another example, a technician of a cable company, going to a field service appointment for installing wireless switches, could have her or his mobile device downloaded with information about an electrical system of the client, which may include electrical devices, utilities, equipment's used in the client's building, but the technician only needs information on the blueprint of the electrical wiring.

According to some embodiments, systems and methods are provided for intelligent priming of mobile devices for the representatives of an organization who make service calls or client visits. With intelligent priming, in some embodiments, the systems and methods analyze each potential service appointment or customer/client visit separately, identify a potential set of information most relevant for the appointment or visit, and download the same to the representatives' mobile device. This reduces the time required and amount of information for priming. In some embodiments, the intelligent priming systems and methods can also notify representatives of when they should prime or download, generate recommendations for the information to be primed or downloaded, and provide an indicator to the representative regarding the status of priming or download.

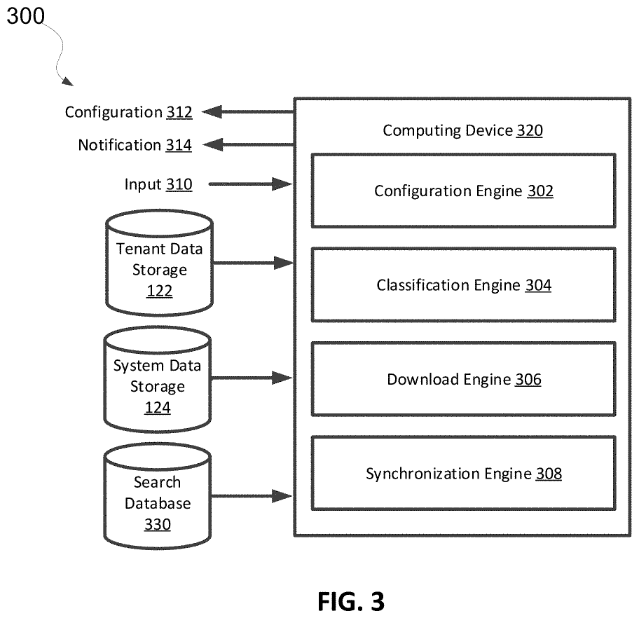

FIG. 3 illustrates a simplified diagram of a system 300 for intelligent priming of a mobile device according to some embodiments. In some embodiments, at least a portion of the system 300 is implemented on a computing device 320. The computing device 320 includes a processor coupled to or in communication with memory (not shown). Operation of the computing device 320 is controlled by the processor. The processor may more comprise one or more central processing units, multi-core processors, microprocessors, microcontrollers, digital signal processors, field programmable gate arrays (FPGAs), application specific integrated circuits (ASICs), graphics processing units (GPUs), tensor processing units (TPUs), and/or the like in computing device 320. Computing device 320 may be implemented as a stand-alone subsystem, as a board added to a computing device, and/or as a virtual machine.

The memory may be used to store software executed by the computing device 320 and/or one or more data structures used during operation of the computing device 320. In some examples, the memory may include one or more types of non-transitory, tangible, machine readable media that includes executable code that when run by one or more processors (e.g., the processor of computing device 320) may cause the one or more processors to perform, among other things, any of the methods described further herein. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

The processor and/or memory of computing device 320 may be arranged in any suitable physical arrangement. In some embodiments, processor and/or memory may be implemented on a same board, in a same package (e.g., system-in-package), on a same chip (e.g., system-on-chip), and/or the like. In some embodiments, processor and/or memory may include distributed, virtualized, and/or containerized computing resources. Consistent with such embodiments, processor and/or memory may be located in one or more data centers and/or cloud computing facilities.

In some embodiments, the computing device 320 of system 300 may be connected to or in communication with one or more components of the multi-tenant database system 116. As shown, these components can include the tenant data storage 122 and system data storage 124 which store or maintain tenant data and system data, respectively. This can include, for example, information regarding a tenant organization's customers (such as contact names, addresses, telephone numbers, etc.), leads, follow-up data, identification of services and products provided or offered to each customer, service or support history for such services and products, service or product agreements, warranty information, schedules or calendars, sales numbers, pending proposals, etc. The information can also include system data, which can be used, for example, to access the data from the database system 116.

In some embodiments, the computing device 320 may be incorporated into the multi-tenant system 116. Computing device 320 may also be connected to or in communication with a search database 330 which can be part of or separate from system 116. Search database 330 can store, maintain, or access other data or information (e.g., external or separate from that maintained in database system 116. This information can, for example, relate to maps, weather, driving instructions, etc. that are available from, e.g., one or more third party sites.

System 300 provides or supports intelligent priming or downloading of information to mobile devices (e.g., user systems 112) of an organization's representatives who provide products, services, support, etc. to customers, clients, leads in the field (e.g., at a client site). The priming or downloading is intelligent in that the system identifies or selects specific information that is particularly relevant for the representatives' appointments or visits.

In some embodiments, for each representative, the system 300 considers or processes each appointment or visit planned or scheduled by that representative (e.g., for a specific timeframe, such as daily or weekly), identifies, classifies, or otherwise selects a set of information that is relevant to each appointment or visit, and downloads the selected set of information to the representative's mobile device. In some embodiments, the system 300 may present, display, or otherwise provide the representative with an indication of the selected set of information before download; the representative may elect to have the selected set primed or downloaded to her or his mobile device, or not. To accomplish this, as shown in FIG. 3, in some embodiments, the computing device 320 includes a configuration engine 302, classification engine 304, download engine 306, synchronization engine 308.

Configuration engine 302 is responsible, at least in part, for maintaining and identifying one or more configurations of information for priming or downloading onto mobile user systems 112 in connection with appointments or visits made by the users or representatives of various organization or entities, e.g., that utilize the CRM system 116 as tenants. In some embodiments, for each such organization or tenant, configuration engine 302 can maintain at least one default configuration. The default configuration can identify or include all of the information that might be relevant for any appointment or visit made by the organization's representatives. The default configuration may be the set of information from which the system 300 selects to identify particularly relevant information for specific appointments or visits. In some embodiments, for each organization using CRM system 116, an administrator may set or configure the default configuration for that organization. As such, each organization can have its own default configuration. In some embodiments, one or more default configurations can be developed for particular industries (e.g., accounting firms, law firms, automotive sales, cable, satellite, or telephony services, etc.), and such default configurations made available to organizations in that those industries.

In some embodiments, the system 300 may present, display, or otherwise provide the representative with an indication of the default configuration of information for priming or download. Configuration engine 302 may, e.g., in conjunction with other parts of system 300, determine, generate, or identify additional configurations for download or priming. Each such configuration may be specific for a particular appointment or visit, as described herein in more detail. According to some embodiments, upon authentication of the representative or user's mobile device 112, the configuration engine 302 presents the default or other configuration dataset associated with the identified service appointment on the mobile device and determines if the user accepts such configuration.

The classification engine 304 is responsible for generating, determining, identifying, selecting, or otherwise classifying sets information, culled or selected from the default configuration information, that may be particularly relevant for specific appointments or visits. In some embodiments, with respect to a particular representative of an organization, the classification engine 304 may operate for each appointment or visit scheduled for the representative for a particular timeframe (e.g., daily, weekly, etc.). In some embodiments, if the user rejects the presented default configuration, the classification engine 304 will generate or determine a different set of information for download or priming. For this, the classification engine 304 accesses information relating to the representative or user's account or the organization to which the user belongs, (e.g., stored in tenant data storage 122 and/or system data storage 124), and classifies or processes them. The information can include, for example, calendar or schedule information (e.g., including times and locations of the appointments or visits), contact information (e.g., names, titles, phone numbers, email addresses, etc. of one or more customer or client contacts), other account information (e.g., types of products or services provided, relevant contracts or terms of service, warranty information, etc.), and other attributed, learned behavior of the user (e.g., the data that user has chosen to prime previously). The classification engine 304 may also access other information, from different sources, that may be relevant or useful for a client or customer visit or appointment. This information can include map information or driving instructions, the distances between the locations for the various appointments/visits, driving time estimates, weather information, etc. In some embodiments, the configuration engine 302 can prompt the user or representative for one or more inputs 310. The entered one or more inputs 310 can be stored in the tenant data storage 112 and/or system data storage 124, and the user's or organization's account features updated.

In some embodiments, classification engine 304 may include, incorporate, or be implemented with any one or a combination of supervised learning methods (e.g., employing one or more of: support vector machines, linear classifiers, Bayesian classifiers, decision trees, decision forests, boosting, neural networks, nearest neighbor analysis, and/or ensemble methods, etc.); f unsupervised learning methods (e.g., employing one or more of: K-means clustering, EM clustering, hierarchical clustering, agglomerative clustering, and/or constraint-based clustering, etc.); and semi-supervised learning method (e.g., employing one or more of: co-training methods, self-training methods, and/or cluster-and-label methods, etc.). In some embodiments, classification engine 304 may include, incorporate, or be implemented with any one or a combinations of active learning methods (e.g., employing one or more of: uncertainty sampling and/or margin-based active learning, etc.) or anomaly detection methods (e.g., employing one or more of: outlier detection, density-based anomaly detection, and/or anomaly detection using single-class classification, etc.).

The download engine 306 is responsible or involved with priming or downloading information to the various users' or representatives' respective mobile devices 112. The download engine 306 may operate in conjunction with one or both of the configuration engine 302 and the classification engine 304. In some instances, the download engine 306 provides priming or downloading of the default configuration presented by the configuration engine 302. In other instances, the download engine 306 provides priming or downloading of the subset of information selected, determined, or classified by the classification engine 304. The download engine 306 may retrieve, pull, or obtain information for priming or download from the tenant data storage 122, system data storage 124, and/or search database 330. The search database 330 can include or access or one or more API servers (e.g. for maps, weather, traffic, etc.) to obtain or retrieve information for potential priming or download.

The synchronization engine 308 is responsible for generating, determining, or identifying recommended or suggested times for priming or downloading of information to user mobile devices 112. In some embodiments, for each user who may be required or requested to make a client or customer visit or service call, the synchronization engine 308 accesses the user's schedule or calendar information (e.g., from tenant data storage 122) to identify upcoming appointments or visits, for example, in a specific period of time (e.g., daily or weekly). The synchronization engine 308 may also access other information to determine or detect whether, for each appointment falling within the specific period, the user would have access to a suitable network connection (e.g., landline, cellular, or wireless) by which the user could access relevant information while on the visit or appointment. This information could be, for example, notes relating to prior visits or appointments where the same or different user learned about or discovered the connectivity issues. The information could also come from other sources, such as a cellular provider indicating areas of coverage and non-coverage for its services. If it is determined or detected that the user would not have access to a reliable network connection during the appointment or visit, the synchronization engine 308 can notify the user (e.g., via any one or a combination of text alert, sound alert, vibration alert, a text message or a phone call to the user's mobile device 112) to encourage the user to prime the required information for the particular appointment.

According to some embodiments, the system 300 can receive one or more inputs 310 from the organizations, including their respective users or representatives, in any suitable form, such as, for example, text message, voice, or selection from list of options; and stores the received one or more inputs 310 to the user's account features in the tenant data storage 112 and/or system data storage 124.

According to some embodiments, all or a portion of system 300 may run on or be incorporated in system 116, with tenant data storage 122, system data storage 124, program code 126, process space 128. The system 300 (e.g., classification engine 304) may learn based upon user inputs, rule sets created by one or more administrators of the various organizations, and/or various training examples. The classification engine 304 may be trained by one or more training datasets, validated by one or more validation datasets, and tested by one or more training datasets. Typically, where training datasets are used, the number of learning examples is small compared to the number of parameters that should be estimated, i.e. the number of solutions that satisfy the constraints given by the training examples is large.

According to some embodiments, the search database 312 may be accessed multiple times based on the same input 310, but the classification engine 304 may be trained differently based on the user's account features and user input 310. In response to each input 310 from the user, the classification engine 304 may recommend different lists or groups of subset information of a default information. Accordingly, the configuration engine 302 may present multiple lists or groups of subset information in response to the one or more submitted inputs 310.

### Operational Flow

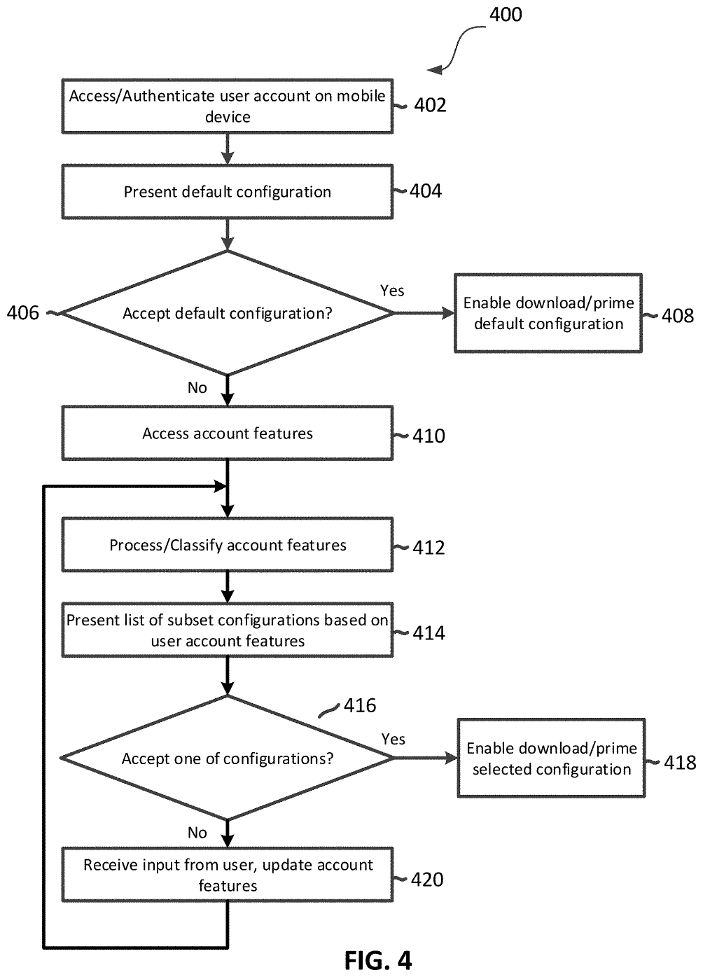

FIG. 4 illustrates a process flow of a method 400 for intelligent priming of a mobile device, according to some embodiments. According to some embodiments, one or more of the processes 402-420 of the method 400 may be implemented, at least in part, in the form of executable code stored on non-transitory, tangible, machine-readable media that when run by one or more processors may cause the one or more processors to perform one or more of the processes 402-420. According to some embodiments, method 400 can be performed by one or more computing devices in systems or diagrams 100, 200, and 300 of FIGS. 1, 2, and 3, respectively, including computing device 320 with configuration engine 302, classification engine 304, download engine 306, and/or synchronization engine 308. Aspects of the processes 402-420 of method 400 have been covered in the description for FIGS. 1, 2, and 3; and additional aspects are provided below.

According to some embodiments, all or a portion of the method 400 may be performed for each appointment or visit for which priming or downloading of information could be desired. At a process 402, in some embodiments, the system 300 may access an account for the user or representative of an organization subscribed to the CRM system 116 and validates the user account authorization.

At a process 404, the configuration engine 302 accesses the respective organization's information stored in the tenant data storage 122, identifies the related pre-defined default configuration of that organization related to the identified appointment, and presents the default configuration to the user or representative (for example, on the mobile device or other user system 112). In some embodiments, the organization or tenant may have multiple default configuration datasets associated with different sections or groups within the organization.

At a process 406, system 300 determines whether the user or representative selects or accepts the default configuration for the particular appointment or visit. If the user accepts the default configuration, then at process 408 the download engine 306 enables or provides priming or downloading of the default configuration. Otherwise, if the user does not accept the default configuration, then at a process 410, the system 300 accesses the user's account features, e.g., stored in tenant data storage 122 and/or system data storage 124.

At a process 412, the classification engine 304 classifies and processes the user's account features based on their likelihood or probability of being particularly relevant to the identified service appointment. In some embodiment, the probabilities may be calculated based on a probabilistic model utilizing a polarity of weights to different parameters of a model, the stored user's account features and/or the one or more user inputs 310 to adjust the balance between the stored user's account features and the one or more inputs 310. In some embodiments, an organization's administrator may set and/or change the polarity of weights applied to the probabilistic model, the different parameters of the stored account features and/or the one or more user inputs 310. In some embodiments, the client's administrator may set and/or change rules on different parameters of the stored account features and/or the one or more user inputs 310. In some embodiments, the client's administrator may set and/or change the confidence interval of the implemented probabilistic model. According to some embodiments, the user's account features' likelihood or probability may be calculated based the recentness of the stored user's account features and the one or more inputs 310 to favor the most recently added information. In some embodiments, the classification engine 304 may set and/or change the polarity of weights on the probabilistic model, the different parameters in the user's account features and/or the one or more user input 310. In some embodiments, any one or more of the above embodiments or any other embodiments described herein are combined.

The classification engine 304, possibly working in conjunction with the configuration engine 302, classifies, generates, or determines a subset of the default configuration information for intelligent priming or download to the user's mobile device 112 for that appointment or visit. In some embodiments, the classification engine 304 classifies the user's account features stored in the tenant data storage 112 and/or system data storage 124, which may include one or more information subsets, defined by the client's administrator. In some embodiments, the user's account features may be updated by inputs 310 from the user. In some examples, a portion of the data stored in the search database 312 is stored in the database (e.g., tenant data storage 122 and/or system data storage 124).

At a process 414, the classification engine 304 presents an identification or indication of the subset default configuration information to the user or representative, for example, by display on the user's mobile device or other user system 112 (e.g., laptop or desktop computer). At a process 416, system 300 determines whether the user selects or accepts the recommended subset of information. In an embodiment where the user selects or accepts the recommended subset, then at process 418 the download engine 306 provides or supports priming or download of the selected subset of information to the user's mobile device. If the user does not select or accept the recommended subsets, the process flows to a process 420.

At process 420, the system 300 prompts the user to enter one or more inputs 310 for further refining or identifying the desired subset of information for download. According to some embodiments, the configuration engine 302 is configured to take one or more inputs 310 from the user in any combinations of text message, voice message, or selection from list of options; and stores the received one or more inputs 310 to the user's account features in the tenant data storage 112 and/or system data storage 124. In some embodiments, the user may direct the one or more inputs 310 to a particular organization. In an example, the user directs the one or more inputs 310 to an organization by, for example, entering the one or more inputs 310 into a search box on computing device 320. In another example, the user directs the one or more inputs 310 to an organization by activating the voice recognition system on the mobile device 300, dictating the input. In another example, the user directs the one or more inputs 310 to an organization by selecting one or more options from a list of recommended options provided by the classification engine 304. The entered one or more inputs 310 can be stored in the tenant data storage 112 and/or system data storage 124, and consequently, the user's account features are updated.

The process flow returns to the process 412 where the classification engine 304 classifies and processes the updated user's account features. With this method, the classification engine 304 may add, and take into account, the one or more inputs 310 to its training, validation, and/or testing datasets, and learn the behavior of the user based on the one or more inputs 310 associated with the identified appointment. Subsequently, the classification engine 304 recommends another subset of default configuration information for potential download on the mobile device to be primed. The processes 412 to 420 may be repeated, until the user accepts one of the presented subsets in step 416.

In some embodiments, one or more actions illustrated in processes 402-420 may be performed for any number of input received by the CRM system. It is also understood that additional processes may be performed before, during, or after processes 402-420 discussed above. It is also understood that one or more of the processes of method 400 described herein may be omitted, combined, or performed in a different sequence as desired.

In an example, for a user who is an accountant with an auditing service appointment for a client, the accountant is authenticated by the computing device 320 subscribed to the CRM system, and presented with the default accounting configuration of the client, which could include auditing, tax accounting, corporate accounting, finance accounting information. However, the accountant does not need to have access to all the different types of accounting information for the auditing service appointment. Thus, the accountant can reject priming the default accounting configuration, and the computing device 320 accesses and classifies the accountant's account features and presents a list of subset information of the default accounting configuration based on the accountant's account features. In an instance where the account does not accept any of the recommended list of different subset information, she or he can enter one or more inputs related to the auditing information of the client, and the accountant's account features is updated accordingly. Consequently, the classification engine 302 presents a new list of subset information based on the newly classified accountant's account features on the mobile device. This process is repeated until the accountant accepts one of the recommended subsets.

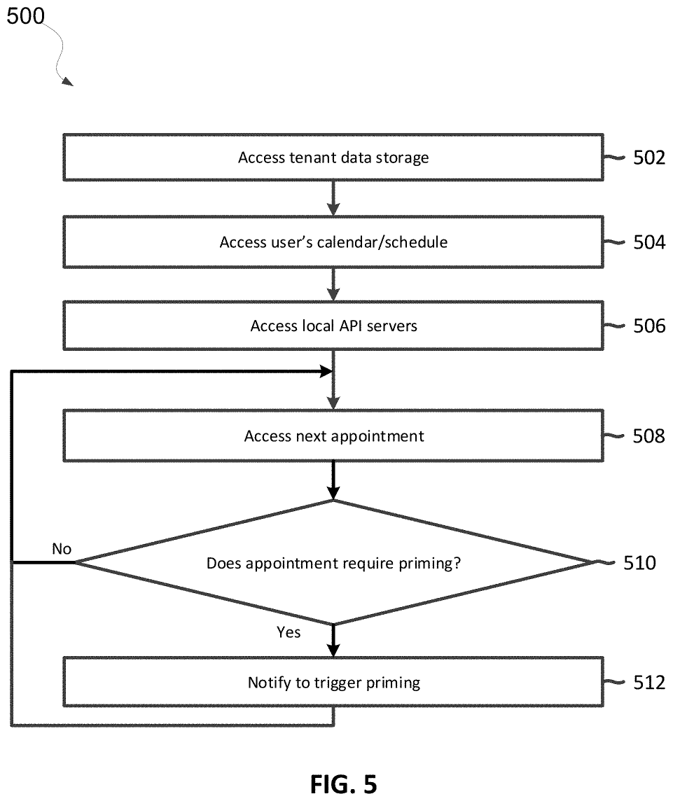

FIG. 5 illustrates a process flow of a method 500 for synchronization of intelligent priming or download, accord to some embodiments. One or more of the processes 502-512 of the method 500 may be implemented, at least in part, in the form of executable code stored on non-transitory, tangible, machine-readable media that when run by one or more processors may cause the one or more processors to perform one or more of the processes 502-512. In some embodiments, method 500 can be performed by one or more computing devices in systems or diagrams 100, 200, and 300 of FIGS. 1, 2, and 3, respectively. In some embodiments, method 500 can correspond to an operation of the synchronization engine 308, configuration engine 301, and/or download engine 302 implemented in the computing device 320. Aspects of the processes 502-512 of method 500 have been covered in the description for FIGS. 1, 2, 3, and 4; and additional aspects are provided below.

According to some embodiments, all or a portion of the method 500 may be performed for each appointment or visit for which priming or downloading of information is desired. At a process 502, the synchronization engine 308 accesses the tenant data storage 122 to identify the organization's information related to the identified appointment, and to identify the user's scheduled appointments.

At a process 504, the synchronization engine 308 accesses the user's calendar/schedule in order to identify, for example, the times and locations of a plurality of field service appointments in the user's schedule information. In some embodiments, the synchronization engine 308 is able to access the user's calendar/schedule 504 for various periods of time (e.g., daily or weekly). At a process 506, the synchronization engine 308 accesses one or more local API servers for other information (e.g., for map or weather).

At a process 510, the synchronization engine 308 processes the accessed or retrieved information (e.g., for the identified appointment's time and location, map, weather, etc.) in order to determine or make a decision as to whether the particular appointment or visit requires priming or downloading of information in advance. For this determination of decision, the synchronization engine can, for example, determine if the user would or would not have access to a reliable network connection (e.g., landline, cellular, or wireless) at the time and location of the identified appointment or visit.

If it is determined that priming or downloading is needed, then at a process 512, the synchronization engine 308 displays or presents a notification 314 (e.g., on the use's mobile device 112 any combination of text alert, sound alert, vibration alert, a text message or a phone call). If it is determined that the identified service appointment does not require priming or downloading, then the process flow returns to process 508, where the synchronization engine 308 processes the next scheduled appointment or visit.

In an example, if a service appointment needs to be done in basement where the network connectivity is poor, a technician attending the service appointment gets a notification, in advance, on his or her mobile device, using the CRM, to trigger priming a required default configuration or a required subset information of the default electrical configuration needed for the service appointment. In another example, if an accountant attending an auditing service appointment for a client, and a cellular tower service near the client's location is down, the accountant gets a notification, in advance, on his or her mobile device to trigger priming a required default configuration or a required subset information of the default accounting configuration needed for the service appointment.

In some embodiments, one or more actions illustrated in processes 502-410 may be performed for any number of input received by the CRM system. It is also understood that additional processes may be performed before, during, or after processes 502-410 discussed above. It is also understood that one or more of the processes of method 500 described herein may be omitted, combined, or performed in a different sequence as desired.

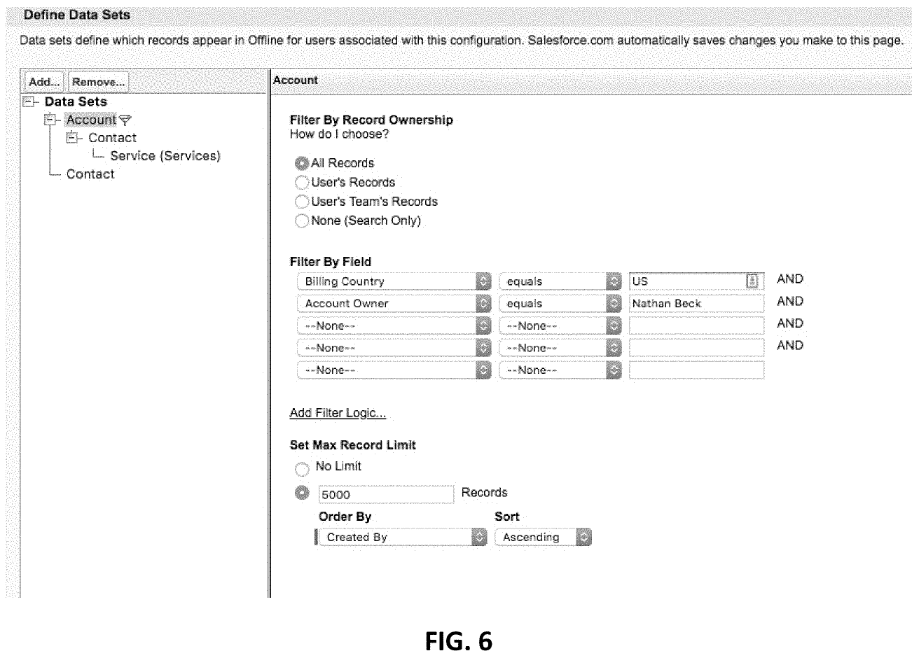

FIG. 6 illustrates a screenshot of a platform for defining or identifying different datasets for possible inclusion in a default configuration dataset of an organization. In some embodiments, the process would be handled or performed by an administrator at the organization. The datasets define or specify which information/records appear offline for a user associated with the configuration. In some embodiments, an administrator of an organization is able to define any dataset of information from the default configuration dataset for different departments or groups of the organization. In some embodiments, the administrator may define a separate set of default configuration information for each department or group.

The different configuration datasets can be defined for different organizations with the goal of achieving useful configuration datasets. The custom-ranked configuration datasets maybe ranked using a logistic regression machine learning model that provides probabilistic coefficients for every configuration that acts as features to the machine learning model. The machine learning model may be trained on data stored in the tenant data storage 122 and/or the system data 125. In an example, the machine learning model is trained on multiple configuration datasets associated with an organization and/or user inputs.

Certain examples of the present disclosure also relate to an apparatus for performing the operations herein. This apparatus may be constructed for the intended purposes, or it may include a general-purpose computer selectively activated or reconfigured by a computer program stored in the computer. Such a computer program may be stored in a computer readable storage medium, such as, but not limited to, any type of disk including floppy disks, optical disks, CDROMs, and magnetic-optical disks, read-only memories (ROMs), random access memories (RAMs), EPROMs, EEPROMs, magnetic or optical cards, or any type of media suitable for storing electronic instructions.

Although illustrative embodiments have been shown and described, a wide range of modifications, changes and substitutions is contemplated in the foregoing disclosure and in some instances, some features of the embodiments may be employed without a corresponding use of other features. One of ordinary skill in the art would recognize many variations, alternatives, and modifications. Thus, the scope of the disclosure should be limited only by the following claims, and it is appropriate that the claims be construed broadly and in a manner consistent with the scope of the embodiments disclosed herein.

What is claimed is:

1. A method for intelligent priming of a mobile device, the method comprising:
maintaining, by one or more processors, a default configuration specifying a set of default information for download on the mobile device;
accessing, by the one or more processors, a database storing schedule information for a field service representative associated with the mobile device;
identifying, by the one or more processors, a plurality of field service appointments in the schedule information;
for each identified appointment:
accessing, by the one or more processors, account information relating to the identified appointment;
processing, by the one or more processors, the account information to identify a subset of default information; and
downloading, by the one or more processors, the subset of default information to the mobile device.

2. The method of claim 1, further comprising:
accessing, by the one or more processors, one or more external databases storing information relating to a network accessibility at the identified appointment's time and location.

3. The method of claim 2, further comprising:
determining, by the one or more processors, whether the identified appointment requires downloading of the subset of default information to the mobile device based on the network accessibility.

4. The method of claim 3, further comprising, in response to determining that the identified appointment requires downloading, generating a notification for the field service representative to trigger downloading on the mobile device, wherein the notification comprises at least one of a text alert, a sound alert, a vibration alert, a text message, and a phone call to the mobile device.

5. The method of claim 1, wherein the account information comprises information relating to at least one of the service appointment and similar service appointments.

6. The method of claim 1, wherein processing comprises:
determining, based on the account information, a probability of relevance to the identified service appointment for each of one or more items in the set of default information; and
including at least some of the one or more items in the subset of default information based on their respective probabilities of relevance.

7. The method of claim 1, further comprising generating an indicator regarding a status of the downloading.

8. A non-transitory machine-readable medium comprising executable code which when executed by one or more processors associated with a computer are adapted to cause the one or more processors to perform a method comprising:
maintaining a default configuration specifying a set of default information for download on the mobile device;
accessing a database storing schedule information for a field service representative associated with a mobile device;
identifying a plurality of field service appointments in the schedule information;
for each identified appointment:
accessing account information relating to the identified appointment;
processing the account information to identify a subset of default information; and
downloading the subset of default information to the mobile device.

9. The non-transitory machine readable medium of claim 8, wherein the method further comprising:
accessing one or more external databases storing information relating to a network accessibility at the identified appointment's time and location.

10. The non-transitory machine readable medium of claim 9, wherein the method further comprising:
determining whether the identified appointment requires downloading of the subset of default information to the mobile device based on the network accessibility.

11. The non-transitory machine readable medium of claim 10, wherein the method further comprising, in response to determining that the identified appointment requires downloading, generating a notification for the field service representative to trigger downloading on the mobile device, wherein the notification comprises at least one of a text alert, a sound alert, a vibration alert, a text message, and a phone call to the mobile device.

12. The non-transitory machine readable medium of claim 8, wherein the account information comprises information relating to at least one of the service appointment and similar service appointments.

13. The non-transitory machine readable medium of claim 8, wherein processing comprises:
determining, based on the account information, a probability of relevance to the identified service appointment for each of one or more items in the set of default information; and
including at least some of the one or more items in the subset of default information based on their respective probabilities of relevance.

14. The non-transitory machine readable medium of claim 8, wherein the method further comprising generating an indicator regarding a status of the downloading.

15. A system for intelligent priming of a mobile device, the system comprising:
a memory containing machine readable medium storing machine executable code; and
one or more processors coupled to the memory and configurable to execute the machine executable code to cause the one or more processors to:
maintain a default configuration specifying a set of default information for download on the mobile device;
access a database storing schedule information for a field service representative associated with the mobile device;
identify a plurality of field service appointments in the schedule information;
for each identified appointment:
access account information relating to the identified appointment;
process the account information to identify a subset of default information; and
download the subset of default information to the mobile device.

16. The system of claim 15, wherein the machine executable code further causes the one or more processors to access one or more external databases storing information relating to a network accessibility at the identified appointment's time and location.

17. The system of claim 16, wherein the machine executable code further causes the one or more processors to determine whether the identified appointment requires downloading the subset of default information to the mobile device based on the network accessibility.

18. The system of claim 17, wherein the machine executable code further causes the one or more processors to, in response to determining that the identified appointment requires downloading, generate a notification for the field service representative to trigger downloading on the mobile device, wherein the notification comprises at least one of a text alert, a sound alert, a vibration alert, a text message, and a phone call to the mobile device.

19. The system of claim 15, wherein the account information comprising information relating to at least one of the service appointment and similar service appointments.

20. The system of claim 15, wherein processing comprises:
determining, based on the account information, a probability of relevance to the identified service appointment for each of one or more items in the set of default information; and
including at least some of the one or more items in the subset of default information based on their respective probabilities of relevance.

21. The system of claim 15, wherein the machine executable code further causes the one or more processors to generate an indicator regarding a status of the downloading.
